(19) United States
(12) Patent Application Publication
(10) Pub. No.: US 2014/0133041 A1
(43) Pub. Date: May 15, 2014

(54) MODULAR OFF-AXIS FIBER OPTIC SOLAR CONCENTRATOR

(71) Applicant: UT-Battelle, LLC., Oak Ridge, TN (US)

(72) Inventor: Lonnie C. Maxey, Powell, TN (US)

(21) Appl. No.: 13/646,781

(22) Filed: Oct. 8, 2012

(51) Int. Cl. G02B 7/183

(52) U.S. Cl. CPC G02B 7/183
USPC 359/853

(57) ABSTRACT

A modular solar concentrator having an aspherical primary reflector that is a segment of a paraboloid parent shape. The peripheral shape of the segment is selected to allow arrangement of an array of concentrators in a closely-fitting pattern. The peripheral shape may be rectilinear or trapezoidal. The primary reflector may be an off-axis segment having an optical axis at or near a peripheral edge. In one embodiment, the modular solar concentrator includes a primary mirror and a secondary minor. In an alternative embodiment, the modular solar concentrator is monolithic having internal surfaces that reflect light into the optical fiber. The monolithic concentrator may include a first internal surface that functions in a manner analogous to a primary mirror and a second internal surface that functions in a manner analogous to a secondary mirror. The optical fiber may be secured in the monolith by an index matching adhesive.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### BACKGROUND OF THE INVENTION

The present invention relates to solar energy, and more particularly to systems and methods for collecting, concentrating and distributing solar light.

The collection and concentration of sunlight for distribution via optical fibers is well known. A variety of companies have commercialized systems that collect sunlight and distribute that light via optical fibers for interior lighting. In the conventional system shown in FIGS. 1 and 2, a solar light concentrator 10 is provided with a single primary minor 12, such as a full parabolic mirror, that reflects light on a centrally located secondary minor 14, such as a curved mirror. The secondary reflector, in turn, reflects the light into optical fibers 16. The optical fibers route the collected light to a luminaire (not shown) for use in interior lighting. These systems are relatively large, including a full parabolic mirror (“parabolic minor system”). A plurality of these solar light concentrators can be installed when it is desirable to collect more light than can be collected by a single concentrator (See, for example, FIG. 2). The primary mirror 12 is typically mounted to a tracking system 18 that moves the solar light concentrator during the day to track the sun. When a plurality of concentrators is installed, each individual solar light concentrator includes its own tracking system. For example, each parabolic minor system is typically supported on a separate mount and is automated by a separate actuator or set of actuators.

In another conventional system, the solar light concentrator includes a plurality of smaller sub-concentrators arranged in an array on a common support structure (“sub-concentrator array system”). Each individual sub-concentrator includes a generally circular lens that focuses light onto a separate optical cable or separate collection of optical cables. For example, the solar light concentrator 20 may include a plurality of sub-concentrators 22 that each include a circular Fresnel lens 24 that focuses light on the end of an underlying optical cable (not shown) (FIG. 3). As another example, the solar light concentrator 30 may include a plurality of sub-concentrators 32 that each includes a conventional lens 34 to focus the light on the optical cable (not shown) (FIG. 5). In both of these examples, the sub-concentrator array is mounted within an enclosure 28, 38 to protect the lens system from the environment. The sub-concentrator support structure is mounted to a single tracking system 26, 36 that allows all of the sub-concentrators carried on the support structure to move together in unison to track the movement of the sun.

These conventional systems inherently suffer from a low fill factor and scalability issues. In the case of parabolic mirror systems (FIG. 1), the amount of solar energy that can be collected is defined by the size of the parabolic mirror. To collect more light, additional units must be installed (FIG. 2). Because of the relatively high profile and large size of these types of solar light concentrators, individual solar light concentrators must typically be spaced fairly far apart to avoid shadowing one another.

In the case of sub-concentrator array systems, a poor fill factor results from the fact that the combined optical collection area of all of the circular lenses (FIGS. 3 and 5) is very small in comparison to the total area of the concentrator. To increase the collection area by any amount, another full concentrator is added (See, for example, FIG. 4).

These conventional systems also suffer from a relatively high profile and related wind loading issues. The height of the parabolic minor system, shown in FIGS. 1 and 2, creates a significant overturning moment that must be considered with regard to roof loading and attachment means, when the units are installed. The large size of the units creates stability issues in even moderate winds, causing noticeable flicker in the collected light level during windy conditions. The sub-concentrator array systems shown in FIGS. 3 and 5 are typically mounted at latitude tilt to minimize the degree of tracking movement required by the individual sub-concentrator units. Due to the large size of the concentrator panels the wind loading is the dominant factor that must be considered when mounting these types of systems to a roof.

Conventional sub-concentrator array systems also have inherently low optical efficiency. As noted above, conventional sub-concentrator array systems include an enclosure to protect the lens systems. The enclosures include a window that allows light to pass from the sun to the lenses. The window of these enclosures significantly reduces the best-case optical efficiency. Reducing the effect of the window losses requires anti-reflective coatings on both sides of the window surfaces, which are much larger than the active optical collection apertures of the individual sub-concentrators. At each optical surface there is a loss in optical efficiency of about 4% due to reflection caused by the mismatch in index of refraction between the air/glass or air/plastic interface. The window and lens each contribute two surfaces and the face of the fiber represents a fifth surface. Consequently, the best-case efficiency for coupling light into the fibers is only 82% (0.96 raised to the fifth power) when the reflections alone are considered.

### SUMMARY OF THE INVENTION

The present invention provides a modular solar concentrator having a primary reflector with a reflecting surface that is a segment of a parent paraboloid. The peripheral shape of the segment is selected to allow an array of modular solar concentrators to be arranged in a closely fitting pattern with an improved fill factor. In one embodiment, the peripheral shape of the segment is a generally rectilinear polygon, such as square or rectangular. In another embodiment, the peripheral shape of the segment is trapezoidal.

In one embodiment, the primary reflector is an off-axis segment of the parent shape having one edge substantially coincident with the optical axis. Although the optical axis may be located at the edge of the segment, it should be understood that precise alignment is not required, and that it may be located near the edge, such as inside or outside the edge. The primary reflector is configured so that the optical axis is disposed at the approximate center of one peripheral edge of the segment.

In one embodiment, the modular solar concentrator includes a primary reflector and a secondary reflector. The primary reflector may be a segment of a parabolic minor and may have a peripheral shape that is a generally rectilinear polygon. The secondary mirror may be a plane mirror arranged to reflect light into an optical fiber. The secondary minor may be mounted to a support disposed at or near the axis of the primary mirror. The optical fiber may be aligned parallel to the optical axis of the primary reflector.

In an alternative embodiment, the modular solar concentrator is a monolithic concentrator in which internal surfaces of the monolithic concentrator reflect light into an optical fiber. The monolithic concentrator may include a first internal surface that functions as a primary reflector and a second internal surface that functions as a secondary reflector.

In one embodiment incorporating a monolithic concentrator, the first internal surface and second internal surface are arranged to take advantage of total internal reflection in reflecting light from the second internal surface to the optical cable. More specifically, the second internal surface may be oriented so that essentially all of the light reflected onto the second internal surface by the first internal surface has an angle of incidence that is greater than the critical angle. In such embodiments, the optical fiber may be oriented normal to the optical axis of the first internal surface to facilitate an appropriate angle of incidence.

In one embodiment incorporating a monolithic concentrator, the optical fiber can be directly inserted into the monolith and secured using an index matching adhesive. For example, when the monolith and optical fiber are polymethyl methacrylate (“PMMA”), an acrylic casting resin may be used as an index matching adhesive.

In one embodiment, the monolithic concentrator may include three high performance coatings, including an anti-reflective coating on the input aperture and reflective coatings on the first and second internal surfaces.

In one embodiment, the present invention includes a plurality of modular solar concentrators arranged in an array. The array may include a regular pattern of essentially identical solar concentrators. In one embodiment, the array is mounted on a single support structure, such as a rectangular panel, allowing the array to be supported on a single mount and moved as one by a single tracking system. In another embodiment, each individual modular solar concentrator may be mounted to separate tracking mechanism, but the separate tracking mechanism may be automated by a single drive system. For example, with a polar-axis mount, a single linear actuator may be coupled to the tracking mechanisms for a plurality of solar concentrators using a unison rod or other similar mechanism.

The present invention provides a simple and effective solar concentrator that provides a variety of significant advantages over conventional systems for collecting, concentrating and distributing solar energy via optical fibers. Depending on the embodiment, these advantages may include improved fill factor and scalability, lower physical profile and wind loading, improved optical efficiency, and lower manufacturing costs when compared to other fiber coupled solar distribution systems. The modular concentration system of the present invention has unlimited scalability. To construct an array of concentrators that would track the sun as a single unit, the concentrators could be assembled with almost 100% fill factor. Alternately, the units could be arranged to form an array in which all of the concentrators track the sun individually by allowing just enough space between the units to prevent one from shading the next. Unlike conventional single-mirror systems, in which each unit must have its own autonomous tracker, the modular concentrator units of the present invention may be mutually aligned so that they may be driven by a single tracking mechanism. Further, modular concentrators mounted on separate mounts need not be mounted higher off of the roof surface than is required to accommodate the tilt of the individual primary mirrors and the collective wind loading is minimal due to the low profile and open space between the concentrators.

Additionally, the modular concentrator of the present invention does not require a window to protect the optical elements and it may be constructed using high efficiency dielectric reflective coatings on the primary mirror and planar secondary minor. These reflective coatings can achieve broadband reflectance efficiencies of ˜98%. The fiber interface will still see a reflective loss of 4% but the net best-case efficiency of the system may be as high as 92% (0.98 x 0.98 x 0.96). That represents a performance enhancement of 12% over the best-case coupling efficiency of the conventional sub-concentrator systems discussed above. It should be noted that concentrating solar systems using plastic optical fibers may be limited in their aperture size, as the energy density increases with increasing aperture size. As aperture sizes become larger, at some point the thermal load on the optical fiber may exceed its performance limits. The use of dielectric coated minors designed to reflect only the visible wavelength portion of the spectrum (so-called “cold minors”) may mitigate these effects.

The present invention provides significant advantages in terms of manufacturing costs. Perhaps the most obvious reduction in manufacturing cost, when comparing the modular concentrator of the present invention to the closest commercial competitor, the parabolic mirror system, accrues from the fact that manufacturing a large precision optical surface is much more difficult than manufacturing a small precision optical surface. Because the modular concentrator invention uses much smaller surface area than the single-mirror system, the ability to achieve the needed surface shape precision over the manufactured area is much greater. A less obvious manufacturing advantage has to do with “sag”, the maximum deviation in the surface height from a planar surface. A full paraboloid surface has relatively large sag. However, the off-axis segment of the present invention may be manufactured with respect to its best-fit plane, reducing the sag by an order of magnitude or more (determined by aperture size) from that of the full parent paraboloid. The manufacturing costs (which increase non-linearly as a function of the surface sag) of the primary minor will be dramatically reduced for the modular concentrator because the aperture and sag have both been reduced.

These and other features and advantages of the present invention will become apparent from the following description of the invention, when viewed in accordance with the accompanying drawings and appended claims.

### BRIEF DESCRIPTION OF THE DRAWINGS

FIG. 1 is a perspective view of a first prior art solar concentrator.

FIG. 2 is a perspective view of a plurality of first prior art solar concentrators.

FIG. 3 is a perspective view of a second prior art solar concentrator.

FIG. 4 is a perspective view of a plurality of second prior art solar concentrators.

FIG. 5 is a perspective view of a third prior art solar concentrator.

FIG. 6 is a top plan view of a parent parabolic mirror.

FIG. 7 is a top plan view of a modular off-axis solar concentrator in accordance with and embodiment of the present invention.

FIG. 8 is a side view of the solar concentrator of FIG. 7.

FIG. 9 is a side view of the solar concentrator showing representative light rays reflecting into an optical fiber.

FIG. 10 is a front view of the solar concentrator of FIG. 9 showing representative light rays reflecting into an optical fiber.

FIG. 11 is a top plan view of an array of solar concentrators.

FIG. 12 is a side view of an array of solar concentrators.

FIG. 13 is a top plan view of a first alternative solar concentrator and an array of solar concentrators in accordance with the first alternative embodiment.

FIG. 14 is a side view of a second alternative solar concentrator.

FIG. 15 is a side view of a third alternative solar concentrator.

FIG. 16 is a side view of a fourth alternative solar concentrator.

FIG. 17 is a side view of a fifth alternative solar concentrator.

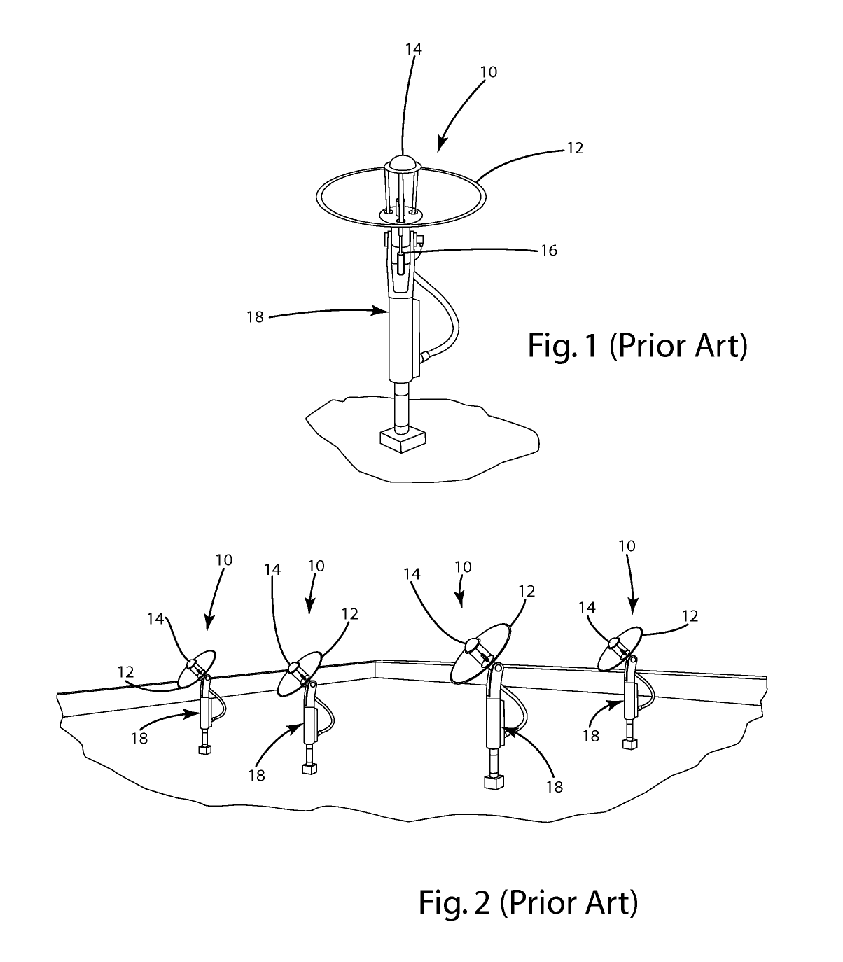

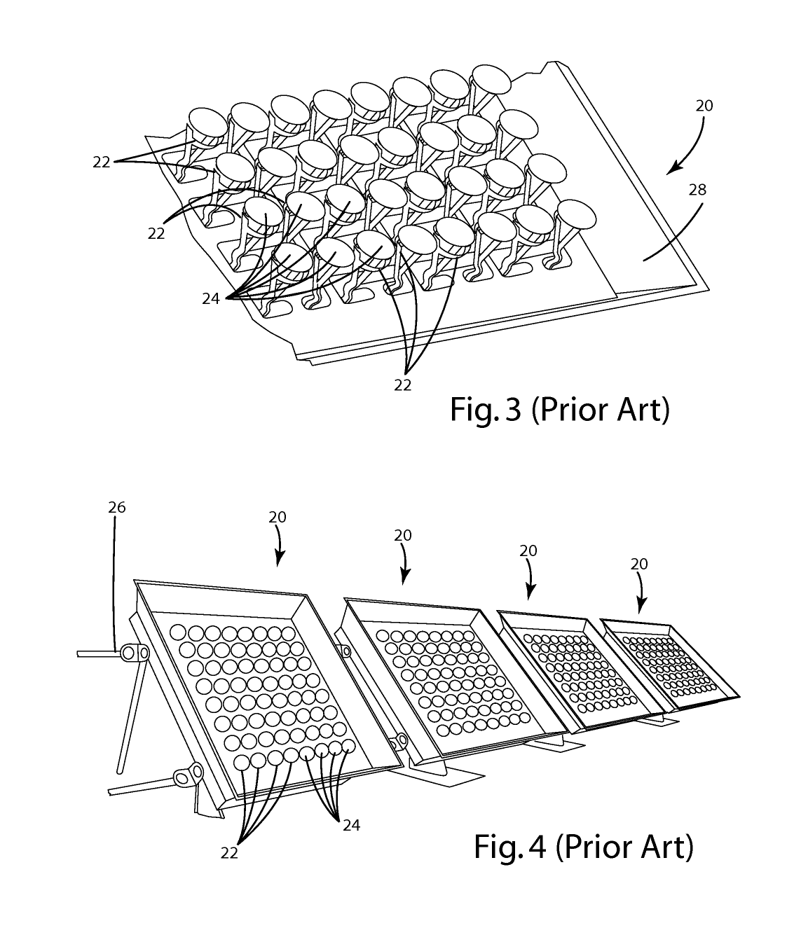

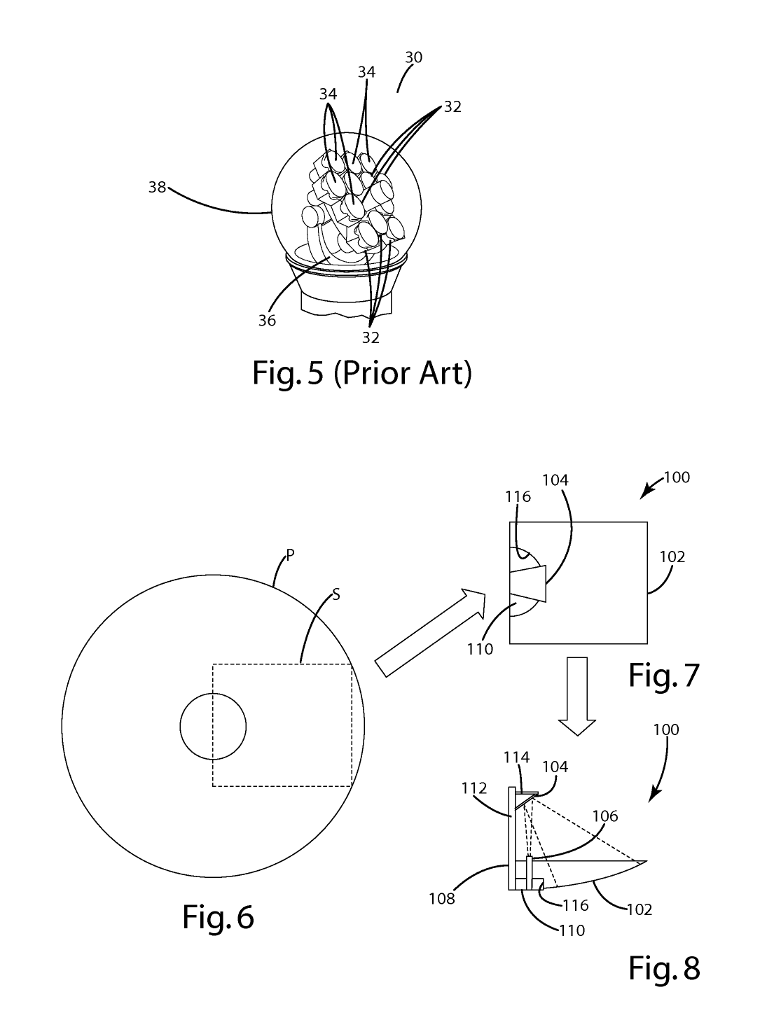

Before the embodiments of the invention are explained in detail, it is to be understood that the invention is not limited to the details of operation or to the details of construction and the arrangement of the components set forth in the following description or illustrated in the drawings. The invention may be implemented in various other embodiments and of being practiced or being carried out in alternative ways not expressly disclosed herein. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### DETAILED DESCRIPTION OF THE CURRENT EMBODIMENTS

A fiber optic solar concentrator 100 in accordance with an embodiment of the present invention is shown in FIGS. 7 and 8. The solar concentrator 100 generally includes a primary reflector 102, a secondary reflector 104 and an optical cable 106. In use, the primary reflector 102 reflects sunlight onto the secondary reflector 104 and the secondary reflector 104 in turn reflects that light into the optical cable 106. The optical cable 106 may extend from the solar concentrator 100 to a remote location where the collected light may be used. For example, the optical cable 106 may route the collected light to a luminaire (not shown) positioned in an interior room to provide interior lighting. In this embodiment, the primary reflector 102 is an aspherical reflector that is a segment of a parent circular parabolic mirror (FIG. 6). The primary reflector 102 of this embodiment is an off-axis segment having an optical axis that is generally aligned and centered along an edge of the primary reflector 102. The secondary reflector 104 may be located at or near the optical axis and be oriented to reflect light rays into optical cable 106. In this embodiment, the primary reflector 102 has a peripheral shape that is generally rectilinear. For example, the shape of the periphery of the primary reflector 102 may be square or rectangular. If desired, a plurality of solar concentrators 100 may be arranged in an array to provide additional light collection with a high fill factor due to their shapes. Further, the number of solar concentrators 100 in the array can be readily adjusted to provide scalability.

The present invention is described in connection with a solar concentrator intended to collect and distribute sunlight via optical fibers for interior lighting. The solar concentrator may, however, be used in other applications were the collection of sunlight is desired (e.g. fiber-coupled photovoltaic systems, high-density indoor agriculture, etc).

Directional terms, such as “vertical,” “horizontal,” “top,” “bottom,” “upper,” “lower,” “inner,” “inwardly,” “outer” and “outwardly,” are used to assist in describing the invention based on the orientation of the embodiment or embodiments shown in the illustrations. The use of directional terms should not be interpreted to limit the invention to any specific orientation(s).

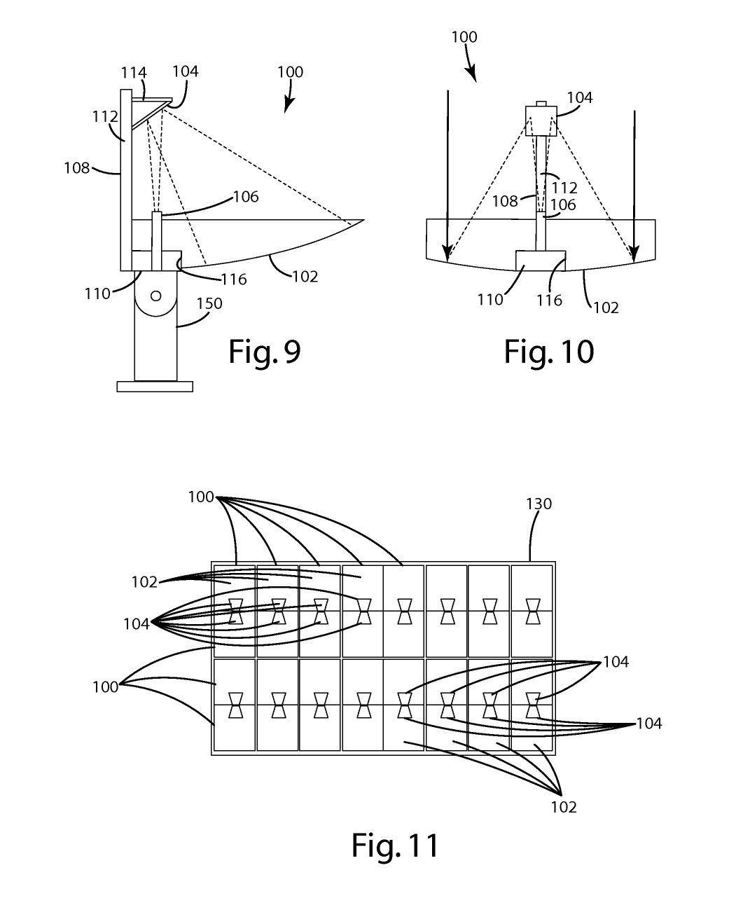

As noted above, the present invention is a directed to a fiber optic solar concentrator 100 having a primary reflector 102, a secondary reflector 104 and an optional fiber 106 (See FIGS. 7-10). The primary reflector 102 may have an aspheric reflecting surface that reflects sunlight onto the secondary reflector 104 (See FIGS. 9, 10 and 12, which shown representation light rays). As perhaps best shown in FIG. 6, the primary reflector 102 of this embodiment has a peripheral shape that is a rectangular segment of a parent parabolic mirror. FIG. 6 shows a full parabolic mirror with a rectangle shown in broken lines to represent the shape of the peripheral of the segment forming the primary reflector 102. In this embodiment, the primary reflector 102 is an off-axis segment of the parent shape. The primary reflector 102 of this embodiment includes an optical axis that is generally aligned with one edge. Although the reflecting surface of the primary reflector 102 of this embodiment is a paraboloid, the present invention may be implemented with a primary reflector having a reflective surface of alternative geometries, including alternative aspheric shapes. The primary reflector 102 may be essentially any type of reflective surface or mirror, with the specific construction being selected to provide an appropriate balance between a variety of factors, such as cost, efficiency and durability. In one embodiment, the primary reflector 102 may be manufactured by applying a reflective coating to a suitable substrate. For example, a reflective coating may be applied to the back surface (i.e. the surface opposite the sun) of a transparent substrate, such as glass or a polycarbonate or other transparent polymeric material. In such embodiments, the front surface (i.e. the surface facing the sun) of the substrate may include an anti-reflective coating. In another example, the reflective coating may be applied to the front surface of a substrate, such as a metal substrate. With either example, the reflective coating may be essentially any suitable reflective coating, such as a thin layer of silver, aluminum or other sufficiently-reflective material. As an alternative simple metal layers, the reflective coating may be a dielectric coating. The dielectric coating may include a variety of different material deposited in thin layers onto the substrate. The reflective coating may be covered by one or more protective coatings, if desired. In an alternative embodiment, the primary reflector 102 may have a highly polished front surface, such as an aluminum surface.

In the illustrated embodiment, the secondary reflector 104 is a plane minor oriented to reflect converging sunlight received from the primary reflector 102 into the optical cable 106 (See FIGS. 9, 10 and 12, which show representative light rays). Although shown as a plane minor, the shape of the secondary reflector 104 may vary from application to application. For example, the secondary reflector 104 may be shaped as a focusing element configured to assist in maximizing the amount of sunlight received from the primary reflector 102 that enters into the end of optical cable 106. As with the primary reflector 102, the secondary reflector 104 may be essentially any type of mirror, with the specific construction being selected to provide an appropriate balance between a variety of factors, such as cost, efficiency and durability. As described above in connection with the primary reflector 102, the secondary reflector 104 may be manufactured by applying a reflective coating to a suitable substrate. For example, a reflective coating may be applied to the backside of a transparent substrate, such as glass or a polycarbonate or other transparent polymeric material. In such applications, an anti-reflective coating may be applied to the front surface of the substrate. In another example, the reflective coating may be applied to the front surface of a substrate, such as a metallic substrate. The reflective coating may be covered by one or more protective coatings, if desired. In an alternative embodiment, the secondary reflector 104 may have a highly polished front surface, such as a polished aluminum surface.

As noted above, the solar concentrator 100 includes an optical cable 106 for routing collected light to one or more remote locations, such as to a luminaire located in an interior room. The optical cable 106 may be essentially any optical cable capable of receiving and routing sunlight. For example, the optical cable 106 may a fiber optic strand or a bundle of fiber optic strands. As perhaps best shown in FIGS. 9 and 10, the optical cable is arranged with its receiving end facing the secondary minor 104 so that the light reflected from the secondary mirror 104 enters the optical cable 106. In this embodiment, the end of the optical cable 106 is positioned at or near the focal point of the secondary minor with respect to light received from the primary reflector 102. For example, the end of the optical cable 106 may be positioned so that it receives light when the converging light beam is slightly smaller than the cross-section of the optical cable 106. In some applications, the energy density of the light supplied to the optical cable 106 may cause the thermal load on the optical fiber to exceed its performance limits. In such applications, it may be possible to reduce the aperture size to limit energy density or to use a “cold mirror” that would reflect primarily or only visible wavelengths. For example, the primary reflector and/or the secondary reflector may be coated with a dielectric coating that allows only visible wavelengths to be reflected.

In the illustrated embodiment, the primary reflector 102, secondary reflector 104 and optical cable 106 are joined together by a support assembly 108 (See FIG. 9). The support assembly 108 generally includes a base 110, a support 112 and an arm 114. The base 110 of this embodiment is joined to the primary reflector 102 at or near the optical axis of the primary reflector 102. For example, the base 110 may be a semicircular structural element mounted coaxially with the optical axis of the primary reflector 102. In this embodiment, the base 110 is of sufficient size to receive and hold the optical cable 106 at the location to receive sunlight from the secondary reflector 104. The primary reflector 102 of this embodiment defines a semicircular void 116 that is disposed coaxially with the axis of the primary reflector 102 and is of sufficient size to closely receive the base 110. The base 110 may be cemented or otherwise secured within the void 116. The support 112 extends from the base 110 in a direction substantially parallel to the optical axis of the primary reflector 102. The support 112 terminates in arm 114 extending from the support 112. In this embodiment, support 112 and arm 114 are configured to hold opposite edges of the secondary reflector 104.

Support assembly 108 is merely exemplary and the primary mirror 102, secondary minor 104 and optical cable 106 may be joined or held in relative position by essentially any suitable alternative structure. For example, the size, shape and configuration of the base 110, support 112 and arm 114 may vary from application to application, as desired. As another example, the base 110, support 112 and arm 114 may be replaced by one or more alternative components capable of supporting the primary reflector 102, secondary reflector 104 and optical cable 106.

The solar concentrator 100 of the illustrated embodiment includes a tracking system 150 capable of moving the primary reflector 102 (and consequently the secondary reflector 104 and optical cable 106) to track the sun as it moves across the sky (See FIG. 9). Solar tracking systems are well-known in the field and therefore will not be described in detail herein. Suffice it to say that the tracking system may incorporate an “alt-azimuth” mount and employ a two-axis motorized drive system, or it may incorporate a “polar” mount and employ a single-axis motorized drive system.

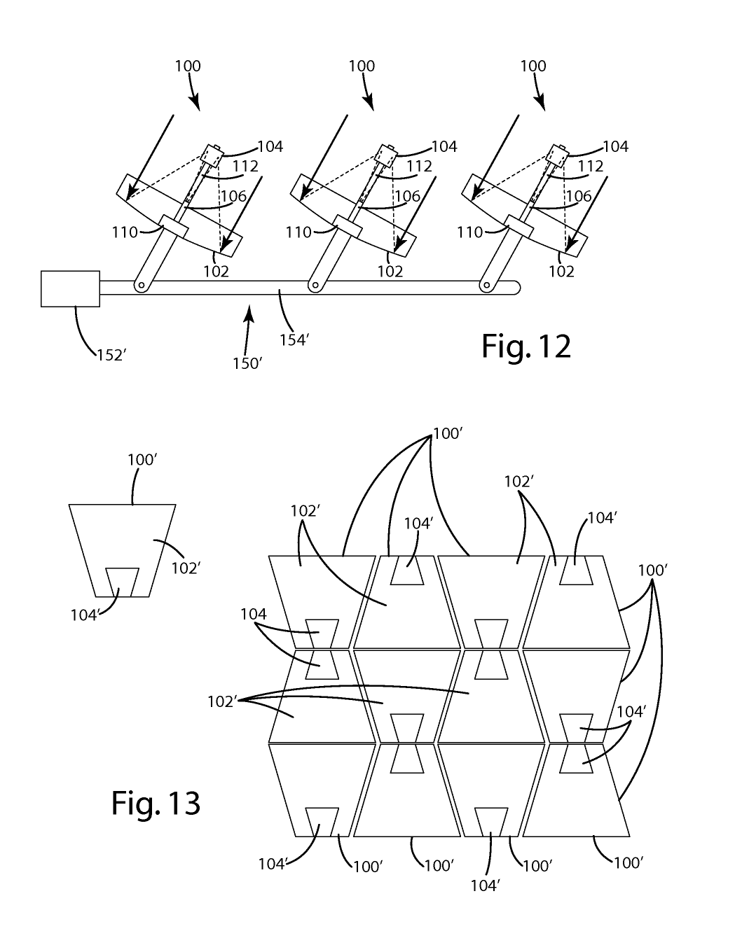

In one embodiment, a plurality of solar concentrators 100 may be combined into an array (See FIGS. 11 and 12) to scale the system to collect the desired amount of sunlight. With the rectangular primary reflectors 102 of the illustrated embodiment, the solar concentrators 100 may be combined into an array with a regular repeating pattern and relatively high fill factor. As shown in FIG. 11, the primary reflectors 102 may be arranged immediately adjacent to one another in a regular repeating pattern. The arrangement of solar concentrators 100 may, however, vary from application to application as desired. In addition to providing a high fill factor, the present invention is easily scalable by adding additional solar concentrators 100 to the array.

As perhaps best shown in FIG. 11, the solar concentrators 100 may be combined into an array by mounting a plurality of solar concentrators 100 onto a common support structure having a single mount and associated tracking system (not shown). For example, the solar concentrators 100 may be mounted to the front surface of a rectangular support panel 130 oriented to face the sun. In this embodiment, the support panel 130 is positioned on a mount with a tracking system (not shown) that allows the support panel 130 and associated solar concentrators 100 to move collectively to track the sun.

As an alternative to common support structure, each solar concentrator 100 may be positioned on a separate mount. In such embodiments, the separate solar concentrators 100 may be arranged in an array with just enough spacing between the solar concentrators 100 to prevent one from shading the next (See FIG. 12). In one embodiment of this approach, each solar concentrator 100 may include a separate autonomous tracking system. However, in an alternative embodiment, the solar concentrators 100 may be mutually aligned so that all of them may be driven by a common tracking system 150′. In the embodiment of FIG. 12, each solar concentrator 100 may be mounted on a separate polar-axis mount and they may be configured to track the sun using a single actuator. As shown in FIG. 12, the system may include a single actuator 152′ that is coupled to each separately mounted solar concentrator 100 by a unison rod 154′ or similar structure capable of communicating coordinated motion of the linear actuator 152′ to each solar concentrator 100.

Although the solar concentrators 100 shown in FIGS. 7-12 have a generally rectangular peripheral shape, the shape of the solar concentrators may vary from application to application. For example, the solar concentrators 100′ shown in FIG. 13 are not rectangular, but instead have a trapezoidal shape. More specifically, the primary reflector 102′ shown in the embodiment of FIG. 13 is trapezoidal in peripheral shape. In this embodiment, the secondary reflector 104′ may be essentially identical to plane minor 104 and may be configured to reflect light onto an optical cable (not shown). As shown in FIG. 13, a plurality of trapezoidal solar concentrators 100′ may be arranged in an alternating pattern to provide an almost complete fill, much like the rectangular solar concentrators 100. The alternative geometry of a trapezoidal primary reflector 102′ is shown merely as an example, and it will be recognized that an infinite constellation of aperture geometries and off-axis angles exists and may be incorporated into alternative embodiments of the present invention.

In the embodiment of FIGS. 7-12 described above, the solar concentrator 100 includes separately manufactured primary and secondary reflectors. As an alternative, the solar concentrator may include a single monolithic structure in which the primary and secondary reflectors are internal surfaces of the monolith. As with the embodiment of FIGS. 7-12, the monolithic solar concentrator may be an off-axis segment of a parent paraboloid, such as full parabolic mirror. The monolithic solar concentrator may have a peripheral shape that is rectilinear or trapezoidal so that a plurality of monolithic concentrators may be arranged in an array in close proximity. The monolithic solar concentrator may have other peripheral shapes that facilitate assembly of an array with a high fill factor.

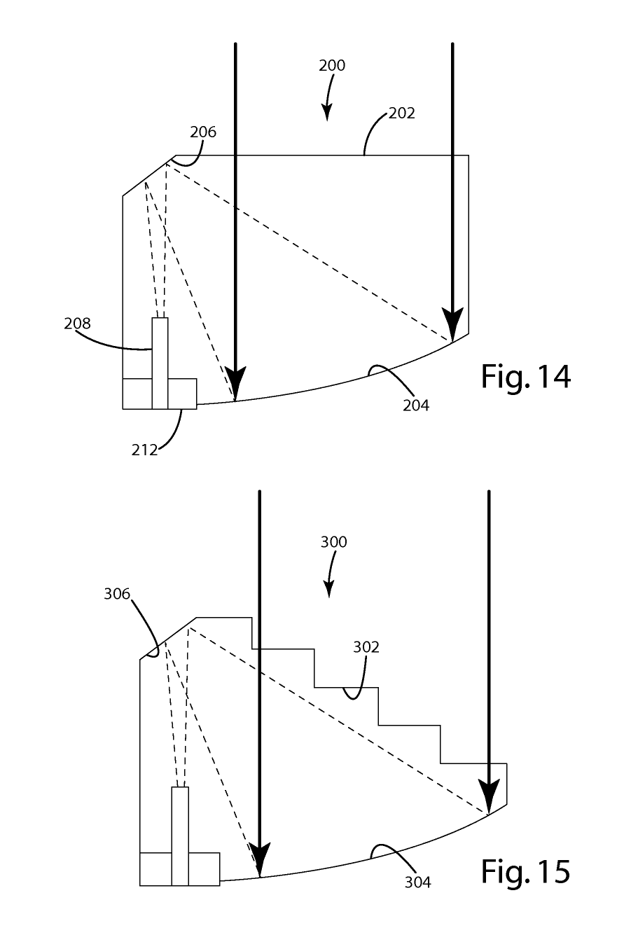

Referring now to FIG. 14, the solar concentrator 200 of this embodiment may include an input aperture 202, a first internal surface 204 that functions as a primary reflector and a second internal surface 206 that functions as a secondary reflector. In this embodiment, the input aperture 202 extends along a plane normal to the optical axis of the monolith. The input aperture 202 may be coated with an anti-reflective coating that reduces reflection and allows more sunlight to enter the monolith. For example, the input aperture 202 may be coated with a multilayer dielectric coating selected to minimize reflections at the interface between the air and the monolith.

In this embodiment, the first internal surface 204 functions in a manner similar to the primary reflector 102—reflecting sunlight toward the second internal surface. The first internal surface 204 may be parabolic in shape providing a reflective internal surface that focuses and reflects sunlight entering the monolith in a direction parallel to the optical axis of the monolith toward the second internal surface 206. The first internal surface 204 may be coated with a reflective coating that causes the first internal surface 204 to function as a high efficiency minor. For example, the first internal surface 204 may be coated with a thin layer of metal or a multilayer dielectric coating.

In this embodiment, the second internal surface 206 functions in a manner similar to the secondary reflector 104—reflecting sunlight received from first internal surface into the receiving end of the optical cable 208. The second internal surface 206 may be planar in shape. As with the first internal surface 204, the second internal surface 206 may be coated with a reflective coating, such as a thin metal layer or a multilayer dielectric coating.

In the embodiment of FIG. 14, the optical cable 208 is disposed within the monolith to receive light reflected by the second internal surface 206. The optical cable 208 may be a single fiber optic strand extending in a direction parallel to the optical axis of the monolith. The optical cable may be cemented in place by an index matching adhesive that effectively causes the monolith and the fiber (excluding the cladding) to become one continuous material for purposes of light transmission. For example, when the monolith and optical fiber are polymethyl methacrylate (“PMMA”), an acrylic casting resin may be used as an index matching adhesive. Suitable acrylic casting resins are available from a variety of known suppliers, such as Electron Microscopy Sciences of Hatfield, Pa. Although an acrylic casting resin is a suitable index matching adhesive for joining PMMA components, other types of index matching adhesives may be employed.

The monolithic solar concentrator 200 may include a base 212 for supporting the optical cable 208 and providing a mounting structure. The base 212 may be a semicircular structure disposed near the optical axis of the monolith. The base 212 may be of sufficient size and shape to receive and support the optical cable 208, and may be configured to be secured to a mount (not shown), such as an “alt-azimuth” mount or a “polar” mount. Although not shown, the monolith solar concentrator may include a tracking system that allows the monolith to be moved to track the motion of the sun. A plurality of monolithic solar concentrators 200 may be mounted together in an array, for example, in any of the array configurations discussed above in connection with solar concentrator 100. The array of monolithic solar concentrators 200 may be mounted together on a single mount or may be individually mounted to separate mounts. When mounted together on a single mount, the array can be moved together using a single tracking system (not shown). When mounted on separate mounts, the solar concentrators 200 may be moved together using a common linkage from a single actuator (or actuator pair) or they may be moved separately using a separate actuator (or actuator pair) for each solar concentrator 200.

In this embodiment, the monolith may be formed from optically clear plastic, such as PMMA or other suitable polymer. Although the main body of the monolithic solar concentrator 200 may be formed from a single contiguous block of material, it is possible to form the monolith by combining more than one block of material. For example, the monolith may be formed by combining a slab that forms the bulk of the monolith with one or more separately manufactured parts that form the high precision surfaces of the monolith. With reference to the illustrated embodiment, the monolith may include a generally rectilinear main slab of material that is combined with a separately manufactured bottom portion. The bottom portion may be configured to define the first internal surface 204 and may be manufactured using high precision manufacturing techniques and apparatus. For example, computer numerically controlled (CNC) machining of slabs or die molding may be used. The separately manufactured bottom portion may be secured to the main slab by index matching adhesive, effectively combining the two parts into one monolith. With PMMA components, the index matching adhesive may, for example, be an acrylic casting resin.

In an alternative embodiment, the monolithic solar concentrator 300 may include a stepped front surface 302 intended primarily to reduce the amount of polymer required to form the monolith. As shown in FIG. 15, the steps may be configured to extend substantially orthogonally with respect to the optical axis of the monolith. Although step size may vary, the amount of reduction in material will vary depending on step size. The steps may be positioned so that they do not extend into the path of light from the first internal surface 304 to the second internal surface 306.

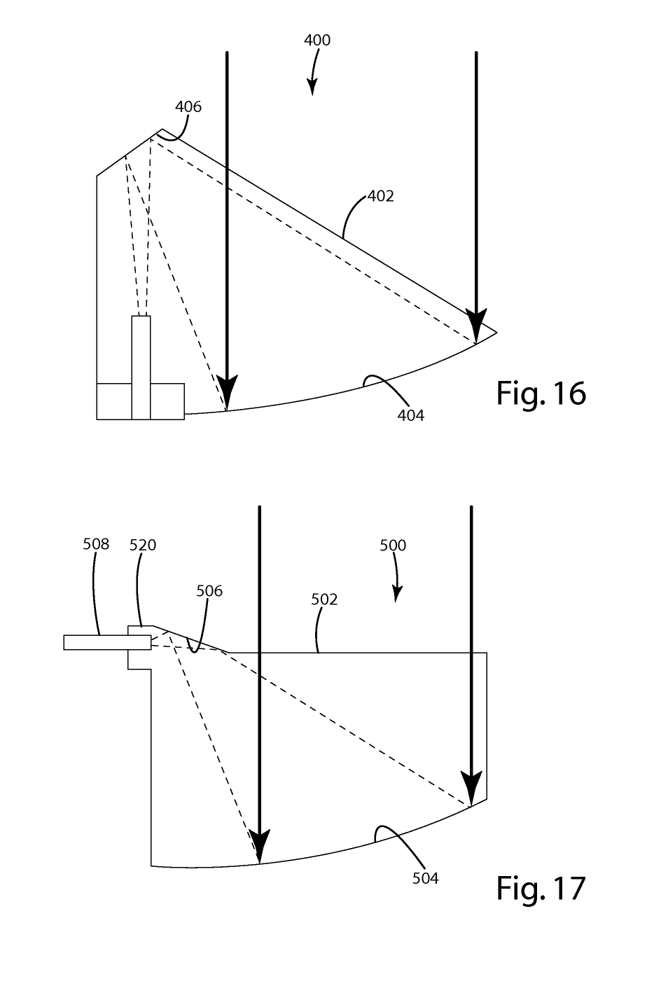

Referring now to FIG. 16, the monolithic solar concentrator 400 may be configured to use less material while maintaining a smooth input aperture 402. In the embodiment of FIG. 16, the stepped surface of the monolithic solar concentrator 300 is replaced by a semi-conical input aperture 402. Although this configuration may provide additional reduction in material, the non-stepped surface will bend light rays in a way that was essentially avoided by the orthogonal stepped configuration. As a result, implementation of a smooth, semi-conical input aperture may require the parabolic first interior surface 404 to be replaced with a generalized aspheric surface, whose design incorporates the refractive effects of the semi-conical input aperture 402.

In the preceding embodiments, the optical cable has been aligned in a direction generally parallel to the optical axis of the primary reflector or first internal surface. In some applications it may be desirable to change the orientation of the optical cable or to allow the use of total internal reflection for the second internal surface. As perhaps best shown in FIG. 17, the monolithic solar concentrator 500 may be configured to concentrate light on an optical cable 508 that extends generally orthogonal to the optical axis. In this embodiment, the second internal surface 504 may be oriented so that it reflects light received from the first internal surface 502 by total internal reflection, rather than utilizing a reflective coating. In this embodiment, it may be desirable to form the monolith with an extension portion 520 configured to receive and support the optical cable 508. Referring again to FIG. 17, it can be seen that the generally orthogonal orientation of the optical cable 508 allows the second internal surface 504 to be oriented so that rays reflected by the first internal surface 502 intercept the second internal surface 504 at angles that are greater than the minimum angle required for the index of the material. For example, if the monolith is formed from PMMA with an air interface at the reflecting boundary, the angle of reflection (as measured relative to the surface normal) would be greater than 42 degrees. Though the angle of the fiber is shown in FIG. 17 to be generally perpendicular to the optical axis of the paraboloid, the angle could actually be parallel to the central ray in the reflected light to provide optimum use of the numerical aperture of the optical fiber. This configuration may provide improved optical efficiency through the enhanced reflectivity of the second internal surface 504 and may provide a reduction in the volume of the monolith relative to the embodiment of FIG. 14. Further reductions in the volume of material used in the monolith may be achieved by introducing a stepped or semi-conical input aperture as discussed above in connection with FIGS. 15 and 16. A reduced volume of material reduces the cost and weight of the monolith.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A solar concentrator comprising:
a primary reflector having a reflecting surface that is defined by a segment of a parent paraboloid, said primary reflector being aspherical and having an off-axis configuration with an optical axis located at or near an edge of said primary reflector;
a secondary reflector positioned adjacent to said primary reflector to receive light reflected by said primary reflector; and
an optical cable positioned adjacent said secondary reflector to receive light reflected by said secondary reflector.

2. The solar concentrator of claim 1 wherein said primary reflector is a parabolic minor and said secondary reflector is a plane mirror.

3. The solar concentrator of claim 1 wherein said primary reflector is rectilinear in peripheral shape.

4. The solar concentrator of claim 1 wherein said primary reflector is trapezoidal in peripheral shape.

5. The solar concentrator of claim 1 wherein said primary reflector and said secondary reflector are defined by internal surfaces of a monolith.

6. The solar concentrator of claim 5 wherein said monolith includes an input aperture, a first internal surface defining said primary reflector and a second internal surface defining said secondary reflector.

7. The solar concentrator of claim 6 further including an anti-reflective coating on said input aperture and a reflective coating on said first internal surface.

8. The solar concentrator of claim 7 further including a reflective coating on said second internal surface.

9. The solar concentrator of claim 7 wherein said first internal surface and said second internal surface are arranged to provide total internal reflection by said second internal surface of light rays received from said first internal surface.

10. The solar concentrator of claim 6 wherein said optical cable is secured within said monolith by an index matching adhesive.

11. The solar concentrator of claim 6 wherein said monolith includes a first portion and a second portion joined together by an index matching adhesive, and the second portion including at least one of said first internal surface or said second internal surface.

12. An array of solar concentrators comprising:
a plurality of modular solar concentrators, each of said modular solar concentrators having a primary reflector, a secondary reflector and an optical cable, each of said primary reflectors being aspherical and having a reflecting surface that is defined by a segment of a parent paraboloid, each of said primary reflectors having a non-circular peripheral shape and an optical axis located at or near a peripheral edge of said primary reflector;
wherein said modular solar concentrators are arranged in a regular repeating pattern with a peripheral edge of one modular solar concentrator located adjacent to a peripheral edge of all adjacent modular solar concentrator, whereby said plurality of modular solar concentrators provide substantially complete fill.

13. The solar concentrator of claim 12 wherein each of said primary reflectors is at least one of rectilinear in peripheral shape or trapezoidal in peripheral shape.

14. The solar concentrator of claim 12 wherein said plurality of modular solar concentrators are carried by a common support structure; and
further including a tracking mechanism, said tracking mechanism including a mount supporting said common support structure and at least one actuator for moving said support structure on said mount to simultaneously cause all of said plurality of modular solar concentrators to track movement of the sun.

15. The solar concentrator of claim 12 wherein each of said plurality of modular solar concentrators includes a separate mount; and
further including an actuator operatively coupled to all of said separate mounts, said actuator being movable to simultaneously move each of said plurality of modular solar concentrators to track movement of the sun.

16. A solar concentrator comprising:
a monolith having a first internal surface defining a primary reflector and a second internal surface defining a secondary reflector, said primary reflector being aspheric and having an optical axis, said first internal surface having a reflective coating; and
an optical cable having an input end mounted within said monolith;
wherein said primary reflector reflects light entering said monolith in a direction parallel to said optical axis toward said secondary reflector and said secondary reflector reflects said reflected light into said optical cable.

17. The solar concentrator of claim 16 wherein said monolith includes an input aperture, said input aperture being coated with a non-reflective coating.

18. The solar concentrator of claim 17 wherein said optical cable is secured within said monolith by an index-matching adhesive.

19. The solar concentrator of claim 18 wherein said second internal surface has a reflective coating.

20. The solar concentrator of claim 18 wherein said first internal surface and said second internal surface are arranged to provide total internal reflection of light rays received from said first internal surface.
